(19) United States
(12) Patent Application Publication
(10) Pub. No.: US 2003/0046140 A1
(43) Pub. Date: Mar. 6, 2003

(54) Methods and systems for delivering market research services via a network

(75) Inventors: Patrick Callahan, Wilton, CT (US); Michael Nydell, Newtown, CT (US)

Correspondence Address: LAW OFFICE OF BARRY R LIPSITZ, 755 MAIN STREET, MONROE, CT, 06468, US

(73) Assignee: Professor Mac, LLC, Southport, CT

(21) Appl. No.: 10/232,011

(22) Filed: Aug. 28, 2002

Related U.S. Application Data
(60) Provisional application No. 60/317,312, filed on Sep. 5, 2001.

(51) Int. Cl. G06F 17/60

(52) U.S. Cl. 705/10

(57) ABSTRACT

The present invention provides methods and apparatus for delivering market research services. A graphical user interface is provided which enables the creation of a customized questionnaire via a network. A database of survey templates accessible over the network via the graphical user interface are provided for use in creating the customized questionnaire. At least one question template for each survey template is provided. The question templates are also accessible over the network via the graphical user interface for use in creating customized questions for the customized questionnaire. Means for distributing the customized questionnaire to desired recipients are provided.

This application claims the benefit of U.S. provisional patent application No. 60/317,312 filed on Sep. 5, 2001.

### BACKGROUND OF THE INVENTION

The present invention provides professional market research software and applications that are simple, intuitive, and fast. In particular, the present invention provides the highest level of professional research functionality, enabling a user to develop, deliver, test and analyze research questionnaires, surveys and projects without the need to utilize or understand “programming”, programming languages, proprietary scripting languages, general scripting or any technical understanding above and beyond that of the normal non-technical computer user. All features and functionality are delivered via a web browser and utilize all the input and interface convention normally associated with that type of simple web interface.

The prior art can be broken down into 4 distinct areas:

1. High-end, full service research firms that are not automated at all.

2. High-end researchers with proprietary software. Some offer Internet enabled packages. The cost is high, they are difficult to use, and often the client needs the researchers to do the work for them through their Professional Services department. Programming skills are required. The Internet implementation is clumsy.

3. Mid-level researchers who offer Internet enabled systems. These systems suffer from a mixture of issues. Some are weak and don't offer professional functionality. The more sophisticated systems require a client to use their scripting language to program a questionnaire. The Internet implementation is clumsy.

4. Low-level basic system that lack professional services or functionality. The ease of use is comfortable and the Internet implementation is well done, but these are not designed for professionals. These systems do not provide research functions, only glorified polling systems.

Professional market researchers need the strength available through high end, conventional (non-automated) research approaches. It would be advantageous to provide a system which allows users to create research questionnaires and surveys ranging from the simplest polls to the most sophisticated and advanced Market Research questionnaires. It would be advantageous to deliver this level of sophistication via the Internet without the associated complication. It would be further advantageous if few to no limits are placed on the questionnaire needs. It would be still further advantageous to enable Call Center phone based studies (CATI) and Internet surveys to be delivered through one central system. Finally, it would be still further advantageous to provide such services wirelessly.

The present invention provides the foregoing and other advantages.

### SUMMARY OF THE INVENTION

The present invention provides professional market research solutions that are simple, intuitive, fast and rich with the professional level functionality required by high-end researchers. In particular, the present invention delivers to business professionals a sophisticated Internet application that allows both market researchers and non-market researchers alike the ability to develop, deliver and analyze market research questionnaires and projects.

The invention provides the ability to create a wide range of market research tools, from simple polls to advanced questionnaires and surveys. The present invention is capable of providing advanced questionnaire logic with skip patterns, logic branching, dynamic question development, answer logic, user profiling, grouping, rotations, randomization, constant sum, panel management, promotional management, user management, professional analysis, intelligent panelist selection, and the like. The present invention delivers this functionality over a network. The network may comprise a global communications network, such as the Internet, with all the advantages and conveniences inherent in such a network. Delivery may be wired or wireless.

Features

The present invention offers features and functionality not available currently in automated packages delivered via the Internet without requiring specialized programming or scripting skills, including:

Professional level strength in features and functionality;

Sophisticated questionnaire creation tools and functionality;

Innovative questionnaire creation and presentation tools;

Full Back Office administrative and business operations tools;

Panel creation and management tools;

Member/Panelist profile and management tools;

Flexible fee and license arrangements for professional market researchers and corporate and small business clients (Enterprise License or ASP versions available);

Panelist promotion/incentive program delivery and management tools;

One system designed to speak to and manage the relationship with clients, members, users and panelists;

Customizable to the client's image and look and feel, scalable and upgradable;

Better designed than competitive products;

Developed to be delivered over wireless web-enabled devices. This will allow for remote survey taking, a key growth area and competitive advantage;

Interface is simple and easy to understand allowing non-research professionals equal and valuable access;

Level of services, features and functionality is very high;

Developed by both research and technology professionals in combination. Other products have been developed by one or the other and have suffered;

Allows for the integration of multimedia in surveys. This will allow companies to copy test ads before production for customer appeal and other video and graphic presentations to be reviewed for consumer impression;

The technology distribution plan of either an Enterprise version or delivery of the application as an ASP (Application Service Provider);

Both the Enterprise edition and the ASP version may be offered to the client base in different versions. This will allow a client to buy an application that most fits their needs as far as functionality, features, and cost;

Overall customer value and return on investment, on a product that is simple to use but yet fully functional and complete is very high;

Both Call Center phone based studies (CATI) and Internet surveys can now be handled through one central system;

Provision of multi-lingual versions;

Easy to use and manage, no programming or scripting skills required;

Delivered over wireless devices, not device dependent. All devices can be included (personal computers, Internet appliances, cell phones, PDA, Blackberry, and the like);

Allows for panel creation and management;

Full email capabilities built into the system;

Incentive and promotion management built in;

Sophisticated mailing and messaging capabilities;

Can be template driven or allow for questionnaires designed from scratch;

Online analysis at any point during the survey;

Report creation and automated delivery;

SPSS compliant analysis downloads. Download data in many formats to allow for offline analysis;

Many different question types built in;

Can upload questionnaires from ASCII or text files;

Sophisticated business logic question creation and referencing (branching, linkages, piping, rotations, randomization, grouping, and the like);

All accessible via the Internet both for the survey taker and the survey administrator. All levels and functionality within the application are wholly Internet-based delivered via a browser.

All the functionality regardless of level or complexity is programmed through a simple GUI interface enabling non-programmers the ability to create a fully functioned survey without the need for programming or scripting skills.

Compatibility

As an Internet-based product there are few issues associated with hardware and operating systems. All development has taken place using Microsoft Internet Development tools and technologies. The invention may be implemented as a Windows 2000 Server Solution. The present invention delivers its surveys via a thin client placing the fewest requirements on the survey taker. Compatibility has been scaled to a low common denominator, which includes older browsers and Internet enabled television systems. This has been completed without compromising critical functionality of the invention. The following listing of technology that can be used to implement the invention is an example only. It should be appreciated that various other software and/or hardware can be used to implement the invention, without departing from the scope of the invention as set forth in the claims appended hereto.

Example Implementation:

Platform: Windows 2000

Server: Windows 2000 Server

Database: SQL Server 2000

Mid Layer Components: ASP and Vbscript. Compiled Visual Basic, Java and C++

Front Layer: HTML, DHTML, Javascript and other various front end technologies.

Detailed Technology Listing

Microsoft SQL Server

MS Transaction Server

COM/DCOM

Visual Basic/VB Script

JAVA/Java script

C/C++

ActiveX

Windows 2000 Development

Active Server Pages (ASP)

DNA (Architecture)

128 bit Secure Encryption

Various Client-side Technologies

Delivery and Access

The present invention may be delivered to the client for their use through two different methods: through licensing software for direct use on an Enterprise wide basis and through an application service provider (ASP).

Professional Site License (Enterprise)

Large research customers, requiring the need to conduct high quality research on a very regular and continuing basis can obtain the present invention by licensing the application for their unlimited use.

This option allows the client complete, unfettered, access to the system without additional costs or limitations. The system will be customized to the client's needs including all graphic representations being designed to match the client's corporate look and standards. This will allow the system to fit comfortably into their Internet presence and visual representation.

The present invention has been designed to be customized, and to allow for additional client functionality customization, within reason. If the client requires certain reports or customized analysis, all of this can be incorporated to their specific licensed package. License fees can be customized according to the package chosen. Maintenance fees may be provided on an annual basis or percentage of overall client revenue basis.

The present invention is designed to easily answer the “Build vs. Buy” question being asked by many Market Research firms today. They realize that Internet-based systems are the way the business is going, but they are not sure what approach is best for them. The present invention helps with this dilemma, as it provides a professional level tool with all the bells and whistles that can be customized to meet the specialized needs of each and every client.

Enterprise License revenue sources include:

1. License fees;

2. Fees for customizing and redevelopment of applications;

3. Maintenance and support retainers and fees;

4. Upgrade policy (per request or subscription based)

5. Hosting and email service fees.

Professional ASP Application

For those clients requiring the ability to execute research programs on an as needed basis, the present invention may be delivered via an ASP approach. The benefit to this approach is that the client can basically “pay as they go” and pay for only what they use.

The ASP application model for business applications is growing in its services to business clients. The application provided by the present invention provides the same services and functionality, regardless of whether it is delivered as a full enterprise license or as an ASP solution.

With the ASP model, the application resides on the providers servers and the client can access it via the Internet and interface with it the same way that the client would if it was installed on the client's own company servers. The many advantages of the ASP model are based around the “pay as you go” business approach. Also, the application is on the providers servers and the provider is responsible for the technical oversight of the application software, all hardware, network and support. It is a “no headaches”, peace of mind business model for the business customer.

ASP revenue sources include:

1. Set up fees;

2. Monthly usage fees;

2. Fees for customizing and redevelopment of applications;

3. Maintenance and support retainers and fees;

4. Upgrade policy (per request or subscription based)

5. Hosting and email service fees.

Several different base-pricing options may be provided for both the Enterprise License and ASP delivery systems. The options may be designed to comfortably fit the needs of users. Depending on the option selected, various levels of customization are also available. The following are examples of various customization levels that may be provided:

Platinum version—Full service option which provides complete system functionality. Includes the full scope of all applications, services, and capabilities. Fully priced.

Gold version—A lighter version than the platinum option, with some compromises made to the features and functionality at a moderate price.

Silver option—A reduced functionality version at a reduced price.

As the application improves and upgrades become available, immediate access to the latest enhancements are provided via the ASP approach. Also, if the Professional Enterprise License approach is selected, the provider can, at the option of the client, host and maintain the application software, all hardware and support. The provider may charge maintenance fees for such services on an annual basis or percentage of overall client revenue basis.

Wireless Enabled Delivery

The present invention may be delivered over hand held, wireless devises. Such a wireless implementation opens up the whole field of research in a way never available before. With the wireless capability, clients can complete:

Mall Research: People can give quick responses to pollsters in the mall and have the data immediately available. No longer will the person need to be dragged into an office within the mall to sit down in front of a computer to take a survey.

In Store Consumer Research: Researcher can approach customers after a purchase has been made to get immediate feedback.

(OTS) On-The-Spot Consumer Research: Whether it is in the store, the movie theater, at a service providers location or at any other location a researcher can approach a person On-The-Spot to get feedback and have that data captured and reported immediately.

Exit Polling: Political exit polling can be brought into the 21st century. The pollster can enter voter results directly into their wireless device at the poll and have the data immediately available in real-time.

Immediate Results: In all these cases, results are reported immediately in real-time. The client can log in remotely via a wireless device and review the results instantaneously in order to keep in touch with the exit polling moment to moment, without delay in the data.

The present invention is designed to satisfy professionals seeking sophisticated applications with all the functionality and services associated with custom packages which possess the breadth of services normally present in conventional, non-automated approaches. The invention enables both companies in the market research space and internal corporate market research divisions to increase efficiency and save precious time and money, by offering a better solution.

Target Market

The present invention was developed with the professional level researcher in mind. The invention was developed to be simple and complete with all the professional level functionality required. Recognizing that many researchers are not technical experts, the invention was developed to take the complicated process of market research and remove the complications while maintaining all the capabilities and required features and functionality. All this is delivered in an easy to use Graphical User Interface (GUI). No knowledge of programming languages or scripting languages are required to utilize the invention.

Most of the prior art products on the Internet are designed with a beginner to novice user in mind. Significant restrictions and limitations are placed on what can be completed. Limited, multi-question research questionnaires can be created with such prior art systems. However, question types, number of questions, answer types, analysis levels, panel types, panelist communications and other features are all factors that are impacted by these limitations. The pricing of these competitive products vary, but in the end, when compared to the value of what is provided in return, the cost is high. Because all these limitations are present in these prior art products, professional and corporate market researchers have not been able to utilize them for high quality research. Beginner researchers and lower-end business users requiring simple/basic multi-question polls have found these systems helpful.

For these reasons, the present invention addresses the marketplace with an all-inclusive, professional level market research product that delivers everything the current systems provide and a great deal more while maintaining a unique level of operational simplicity. The present invention targets the novice to professional level user who is accustomed to the high level capabilities and services present in the conventional/non-Internet based professional market research community.

The present invention provides all the capabilities available in high-level conventional approaches and automates them, without the complications. This is accomplished without reducing the functionality. Little to no training is involved.

The present invention is designed to be customizable to the client's needs. A client can update the look and feel to match a corporate image and presentation, as well as add specialized functionality required by the client's company. The present invention is designed to be customized and scalable. As the industry changes and new advancements are required, the present invention can be upgraded and adapted to meet the challenge.

The present invention may be Internet-based and delivered via a web browser with a GUI interface. No programming or technical skills are required. The complexity, level of services and sophistication are comfortably in the high-end range. The present invention also meets all the needs of the middle layer and lower layer researchers.

### BRIEF DESCRIPTION OF THE DRAWING

The present invention will hereinafter be described in conjunction with the appended drawing figures, wherein like numerals denote like elements, and:

FIG. 1 shows a block diagram of an example embodiment of the invention; and

FIG. 2 shows a flow chart of an example embodiment of the invention.

### DETAILED DESCRIPTION OF THE INVENTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an example embodiment of the invention. It should be understood that various changes may be made in the function and arrangement of elements without departing from the spirit and scope of the invention as set forth in the appended claims.

The present invention provides methods and apparatus for conducting professional market research that are simple, feature rich, intuitive, and fast. In particular, the present invention delivers to business professionals a sophisticated Internet application that allows both market researchers and non-market researchers alike the ability to develop, deliver and analyze research questionnaires, surveys and projects.

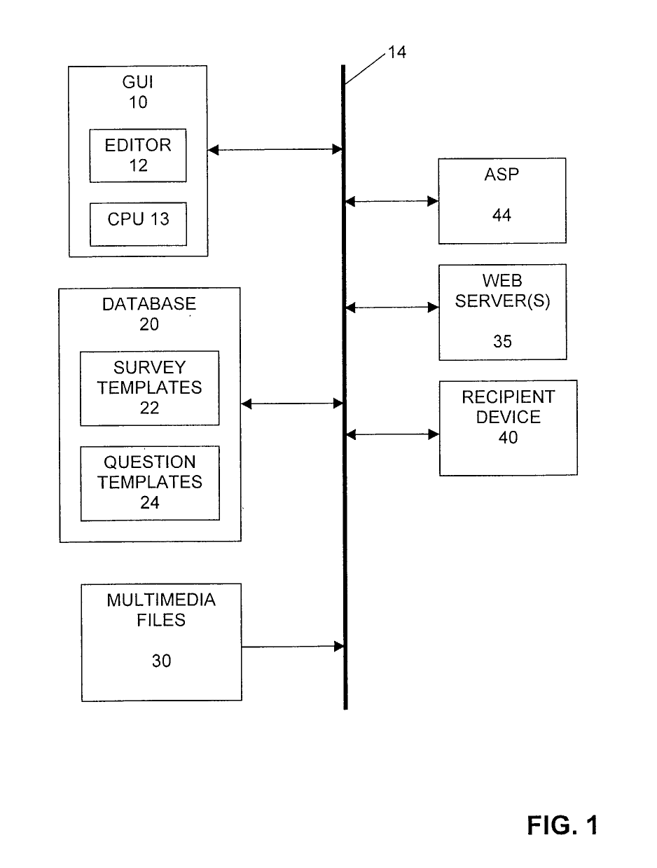

The present invention provides methods and apparatus for delivering market research services. As shown in FIG. 1, a network 14 is provided. A graphical user interface (GUI) 10 is provided which enables the creation of a customized questionnaire via the network 14. A database of survey templates 22 accessible over the network 14 via the graphical user interface 10 is provided for use in creating the customized questionnaire. At least one question template 24 for each survey template 22 is provided. The question templates 24 are also accessible over the network 14 via the graphical user interface 10 for use in creating customized questions for the customized questionnaire. Means for distributing the customized questionnaire to desired recipients are provided. The questionnaire may be received at a recipient device 40.

It should be appreciated that the survey templates 22 and the question templates 24 may be part of a single database 20 as shown in FIG. 1. Alternatively, the survey templates 22 and the question templates 24 may be provided as separate databases which are independently accessed via the network 14.

Results of the questionnaire may be automatically analyzed (e.g., by a processor 13 associated with the GUI 10 or by an Application Service Provider (ASP) 44). A report may be created based on the analysis. The report may be provided to a survey initiator via the network 14. The customized questionnaire may be delivered to the desired recipients 40 over the network 14. For example, the customized questionnaire may be delivered to the desired recipients 40 via email.

Multimedia files 30 may be uploaded for inclusion in the customized questionnaire. The multimedia files 30 may include at least one of photographs, graphics, animated clips, video clips, audio clips, audiovisual clips, and the like. The multimedia files may comprise at least one of a company logo, a product logo, an advertisement, a product description, or the like.

The customized questionnaire may be delivered in the form of an interactive web page.

In a further example embodiment, logic driven question creation may be provided, wherein an answer to a first question can be linked to a subsequent question.

The customized questionnaire may be delivered via a wireless communication network.

Access to the graphical user interface 01 may be provided by an application service provider 44 or by local software (e.g., software purchased by the user and running on a user's computer).

An incentive may be provided to at least one of the desired recipients for completion of the questionnaire.

Secure access to the graphical user interface 10 may be provided. The graphical user interface 10 may include a text-based editor 12 to enable the creation of the customized questions. Therefore, the highest level of research functionality is provided without the need to utilize or understand “programming”, programming languages, proprietary scripting languages, general scripting or any technical understanding above and beyond that of the normal non-technical computer user. For example, all features and functionality of the invention may be delivered via the graphical user interface 10 presented via a web browser and utilize all the input and interface conventions normally associated with that type of simple web interface.

Those skilled in the art will appreciate that one or 15 more web servers 35 may be used to implement the invention. The web servers 35 may be controlled by the ASP 44 or by the user/client, and may include a transaction server and a database server as is known in the art.

The customized questionnaire may be provided in multi-lingual versions to the desired recipients.

A user may download results from the customized questionnaire.

Questions may be uploaded for inclusion in the customized questionnaire, for example from the users PC. The customized questions may be created without use of the question templates (e.g., by uploading questions or drafting them using the text-based editor 12).

The graphical user interface 10 may be accessible via one of a personal computer, an Internet appliance, a personal digital assistant, a cellular telephone, or similar device.

The customized questionnaire may be received by a desired recipient at a recipient device 40, such as a personal computer, an Internet appliance, a personal digital assistant, a cellular telephone, or similar device.

The network 14 may comprise a global communication Network, a local area network, a wide area network, or similar network.

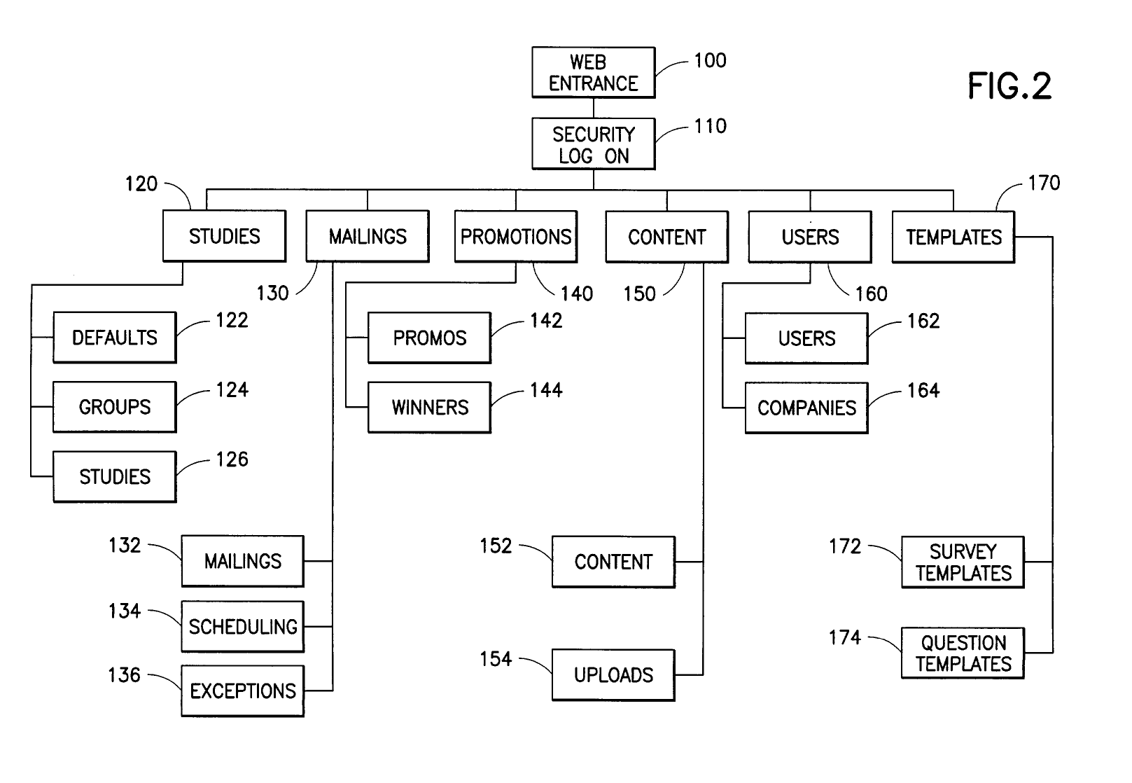

FIG. 2 shows a flowchart of an example embodiment of the invention. A user may access the network through a web entrance 100, such as an ASP portal or the like. A Security log on feature 110 may optionally be provided. Once online, a user may create a customized questionnaire or survey via the graphical user interface using the studies function 120, the mailings function 130, the promotions function 140, the content function 150, the users function 160, and the template function 170.

The studies function 120 provides default features 122, which provides default settings for each new survey or questionnaire. The groups feature 124 is used to organize the surveys or questionnaires, for example for use in creating a mailing. The studies feature 126 provides the ability to create, edit, copy and manage the questionnaires.

The mailings function 130 includes mailings feature 132 for creating and execute all mailings, bulk mailings management, and the creation and management of templates. The scheduling feature 134 is used to determine when an automated mailing will occur. An exceptions feature 136 is provided to exclude individuals or domains from receiving particular mailings.

The promotions function 140 includes a promos feature 142 for managing all promotional and incentive programs associated with the surveys and questionnaires, and to assign prizes to the surveys. A winners feature 144 manages the prize winners across multiple promotions.

The content function 150 provides content feature 152 which encompass all editable content, including the ability to edit text and graphics using the text based editor. An upload feature 154 allows the uploading of files to be added to the content, such as prepared questions, graphics, multimedia files, and the like.

The users function 160 includes a users feature 162 which manages users of the system, including the categorization and assignment of privileges, management of user profiles, and password management. A companies feature 164 manages the companies using the system.

The templates function 170 includes a survey templates feature 172 and a question templates feature 174. The survey question feature 172 provides the ability to create new surveys from old surveys or templates. Folders may be used to organize the templates for easy look-up. The question templates feature 174 provides pre-built questions which can be extended or modified by the user to create complex customized questions. Folders may be used to organize the question templates for easy look-up.

It should be appreciated that the present invention provides advantageous methods and systems for providing market research services over a network.

Although the invention has been described in connection with various illustrated embodiments, numerous modifications and adaptations may be made thereto without departing from the spirit and scope of the invention as set forth in the claims.

What is claimed is:

1. A method for delivering market research services over a network, comprising the steps of:
providing a graphical user interface enabling the creation of a customized questionnaire via said network;
providing a database of survey templates accessible over said network via the graphical user interface for use in creating said customized questionnaire;
providing at least one question template for each survey template, said question templates accessible over said network via the graphical user interface for use in creating customized questions for said customized questionnaire; and
distributing said customized questionnaire to desired recipients.

2. A method in accordance with claim 1, further comprising:
automatically analyzing results of said questionnaire;
creating a report based on said analysis; and
providing said report to a survey initiator.

3. A method in accordance with claim 1, wherein said customized questionnaire is delivered to said desired recipients over said network.

4. A method in accordance with claim 3, wherein said customized questionnaire is delivered to said desired recipients via email.

5. A method in accordance with claim 3, further comprising:
uploading multimedia files for inclusion in said customized questionnaire.

6. A method in accordance with claim 5, wherein said multimedia files include at least one of photographs, graphics, animated clips, video clips, audio clips, and audiovisual clips.

7. A method in accordance with claim 5, wherein said multimedia files comprise at least one of a company logo, a product logo, an advertisement, and a product description.

8. A method in accordance with claim 3, wherein said customized questionnaire is delivered in the form of an interactive web page.

9. A method in accordance with claim 8, further comprising:
providing logic driven question creation wherein an answer to a first question can be linked to a subsequent question.

10. A method in accordance with claim 1, wherein customized questionnaire is delivered via a wireless communication network.

11. A method in accordance with claim 1, wherein access to said graphical user interface is provided by an application service provider or by local software.

12. A method in accordance with claim 1, further comprising:
providing an incentive to at least one of said desired recipients for completion of said questionnaire.

13. A method in accordance-with claim 1, further comprising:
providing secure access to said graphical user interface.

14. A method in accordance with claim 1, wherein said graphical user interface includes a text based editor to enable said creation of said customized questions.

15. A method in accordance with claim 1, wherein said customized questionnaire is provided in multi-lingual versions to said desired recipients.

16. A method in accordance with claim 1, further comprising:
downloading results from said customized questionnaire.

17. A method in accordance with claim 1, further comprising:
uploading questions for inclusion in said customized questionnaire.

18. A method in accordance with claim 1, further comprising:
creating said customized questions without use of said question templates.

19. A method in accordance with claim 1, wherein said graphical user interface is accessible via one of a personal computer, an Internet appliance, a personal digital assistant, or a cellular telephone.

20. A method in accordance with claim 1, wherein said customized questionnaire is received by said desired recipient via one of a personal computer, an Internet appliance, a personal digital assistant, or a cellular telephone.

21. A method in accordance with claim 1, wherein said network comprises one of a global communication network, a local area network, or a wide area network.

22. A system for delivering market research services, comprising:
a network;
a graphical user interface enabling the creation of a customized questionnaire via said network;
a database of survey templates accessible over said network via the graphical user interface for use in creating said customized questionnaire;
at least one question template for each survey template, said question templates accessible over said network via the graphical user interface for use in creating customized questions for said customized questionnaire; and
means for distributing said customized questionnaire to desired recipients.
